(19) United States
(12) Patent Application Publication
(10) Pub. No.: US 2017/0250022 A1
(43) Pub. Date: Aug. 31, 2017

(54) MULTILAYER CERAMIC ELECTRONIC COMPONENT AND MANUFACTURING METHOD THEREFOR

(71) Applicant: Murata Manufacturing Co., Ltd., Nagaokakyo-shi (JP)

(72) Inventor: Jyunichi NANJO, Nagaokakyo-shi (JP)

(21) Appl. No.: 15/593,488

(22) Filed: May 12, 2017

Related U.S. Application Data
(63) Continuation of application No. PCT/JP2015/084275, filed on Dec. 7, 2015.

(30) Foreign Application Priority Data
Dec. 17, 2014 (JP) 2014-254791

(51) Int. Cl. H01F 27/245; H01F 27/40; H01F 41/04; H01F 27/28; H01F 41/02

(52) U.S. Cl. CPC H01F 27/245; H01F 27/2804; H01F 41/0233; H01F 41/046; H01F 27/40; H01F 2027/2809

(57) ABSTRACT

A multilayer body includes laminated ceramic sheets. An IC and passive elements are mounted on a top surface of the multilayer body, and cavities are provided in side surfaces of the multilayer body. Bonding electrodes are provided in bottom surfaces of the cavities. A sealing resin is provided on the top surface of the multilayer body to seal the IC and the passive elements, and extends into the cavities to seal the bonding electrodes.

### CROSS REFERENCE TO RELATED APPLICATIONS

This application claims the benefit of priority to Japanese Patent Application No. 2014-254791 filed on Dec. 17, 2014 and is a Continuation Application of PCT Application No. PCT/JP2015/084275 filed on Dec. 7, 2015. The entire contents of each application are hereby incorporated herein by reference.

### BACKGROUND OF THE INVENTION

### 1. Field of the Invention

The present invention relates to a multilayer ceramic electronic component and a manufacturing method therefor, and more particularly relates to a multilayer ceramic electronic component that includes a multilayer body including a plurality of laminated ceramic sheets each including a plurality of electrode patterns provided thereon or therein and a sealing resin provided on one main surface of the multilayer body, and a manufacturing method therefor.

### 2. Description of the Related Art

Japanese Unexamined Patent Application Publication No. 2006-253716 discloses an example of this type of electronic component. According to Japanese Unexamined Patent Application Publication No. 2006-253716, cutouts are formed in side surfaces of an electronic component body. Bonding electrodes, which are obtained by dividing a bonding via hole conductor, are formed in portions of bottom surfaces of the cutouts. A metal cover having legs is secured to the electronic component body. At this time, the legs are disposed in the cutouts and bonded to the bonding electrodes by soldering or a conductive adhesive.

However, in the multilayer ceramic electronic component, electrochemical migration may occur inside a multilayer substrate due to moisture absorbed from an area between the bonding electrode and the ceramic. When the multilayer ceramic electronic component is mounted on a mother board by reflow soldering, a short circuit may occur at an unintended portion, such as the middle of mounted components due to a wetting-up of the solder.

### SUMMARY OF THE INVENTION

Preferred embodiments of the present invention provide multilayer ceramic electronic components that are able to reduce a risk of absorption of moisture from an area between a bonding electrode and ceramic and a risk of wetting-up of solder, and also provide manufacturing methods therefor.

A multilayer ceramic electronic component according to a preferred embodiment of the present invention includes a multilayer body including a plurality of laminated ceramic sheets each including a plurality of electrodes, and a sealing resin provided on one main surface of the multilayer body. The plurality of electrodes define a bonding electrode extending in a lamination direction of the multilayer body. The plurality of ceramic sheets each include a plurality of cutouts to define a cavity that is provided on a side surface of the multilayer body so as to extend to the bonding electrode. The sealing resin extends from the one main surface of the multilayer body into the cavity in order to seal the bonding electrode.

The side surface of the multilayer body is preferably a flat surface, except for an area of the cavity of the side surface of the multilayer body, and a surface of the sealing resin extending into the cavity is preferably flush with the flat surface.

At least one of the plurality of ceramic sheets is preferably a magnetic ceramic sheet, and the multilayer ceramic electronic component preferably further includes a coil-shaped conductive pattern provided on or in the magnetic ceramic sheet.

The multilayer ceramic electronic component preferably further includes another electronic component that is mounted on the one main surface of the multilayer body and sealed with the sealing resin.

The multilayer ceramic electronic component preferably further includes an outer electrode that continuously extends from the bonding electrode on the other main surface of the multilayer body.

A manufacturing method for a multilayer ceramic electronic component according to a preferred embodiment of the present invention includes a preparation step of preparing a plurality of ceramic sheets each of which includes a first through hole at a common position, a first filling step of filling the first through hole provided in each of the plurality of ceramic sheets with conductive paste to form a bonding electrode; a second through hole forming step of forming a second through hole in each of the plurality of ceramic sheets so as to remove a portion of the conductive paste with which the first through hole is filled in the first filling step, a laminating step of laminating the plurality of ceramic sheets so as to overlap the second through holes in a plan view, to produce a multilayer substrate, a resin applying step of applying a liquid sealing resin to one main surface of the multilayer substrate such that the sealing resin extends into the second through holes, and a dicing step of dicing the multilayer substrate at a position across the second through holes, after the resin applying step.

At least one of the plurality of ceramic sheets is preferably a magnetic ceramic sheet. The method preferably further includes a conductive pattern forming step of forming a coil-shaped conductive pattern on or in the magnetic ceramic sheet, a third through hole forming step of forming a third through hole in at least one of the plurality of ceramic sheets so as to connect the conductive pattern formed in the conductive pattern forming step in a helical manner, and a second filling step of filling the third through hole formed in the third through hole forming step with the conductive paste. The laminating step is preferably performed after the second filling step.

The manufacturing method preferably further includes a mounting step of mounting another electronic component on the one main surface of the multilayer substrate, prior to the resin applying step.

The manufacturing method preferably further includes an outer electrode forming step of forming an outer electrode on the other main surface of the multilayer substrate in a continuous manner from the bonding electrode, prior to the resin applying step.

The manufacturing method preferably further includes an adhering step of adhering a tape on the other main surface of the multilayer substrate, prior to the resin applying step.

A manufacturing method for a multilayer ceramic electronic component according to a preferred embodiment of the present invention includes a preparation step of preparing a plurality of ceramic sheets each of which includes a first through hole formed at a common position, a first filling step of filling the first through hole formed in each of the plurality of ceramic sheets with conductive paste to form a bonding electrode; a laminating step of laminating the plurality of ceramic sheets so as to overlap the first through holes in a plan view, to produce a multilayer substrate, a second through hole forming step of forming a second through hole in the multilayer substrate so as to remove a portion of the conductive paste with which the first through hole is filled in the first filling step, a resin applying step of applying a liquid sealing resin to one main surface of the multilayer substrate such that the sealing resin extends into the second through hole, and a dicing step of dicing the multilayer substrate at a position across the second through hole, after the resin applying step.

According to various preferred embodiments of the present invention, the multilayer body includes the plurality of laminated ceramic sheets each including the plurality of electrodes. The electrodes provided on or in the individual ceramic sheets define the bonding electrode extending in the lamination direction of the multilayer body. The cavity is provided at the side surface of the multilayer body so as to extend to the bonding electrode. Based on this structure, the sealing resin provided on the one main surface of the multilayer body extends into the cavity in order to seal the bonding electrode.

Using the resin as a material of a component to seal the one main surface of the multilayer body and the bonding electrode reduces a risk of absorption of moisture from an area between the bonding electrode and ceramic, and reduces a risk of a wetting-up of solder that bonds between the multilayer ceramic electronic component and a mother board to reach the one main surface of the multilayer body through the cavity.

According to a manufacturing method for a multilayer ceramic electronic component according to a preferred embodiment of the present invention, the sealing resin is applied to the one main surface of the multilayer substrate such that the sealing resin extends into the second through holes. This allows sealing of the one main surface of the multilayer substrate and the bonding electrode exposed at inner peripheral surfaces of the second through holes. By dicing the multilayer substrate at a position across the second through holes after the application, the multilayer ceramic electronic component is completed.

Using the resin as a material of a component to seal the one main surface of the multilayer body and the bonding electrode allows reducing a risk of absorption of moisture from an area between the bonding electrode and ceramic, and a risk of a wetting-up of solder that bonds between the multilayer ceramic electronic component and a mother board to reach the one main surface of the multilayer body through a cavity corresponding to the second through holes.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a state of a multilayer ceramic electronic component according to a preferred embodiment of the present application viewed obliquely from above.

FIG. 2 is an exploded view showing a state of taking apart a multilayer body of the multilayer ceramic electronic component.

FIG. 3A includes a plan view of an example of a ceramic sheet SH0 of the multilayer body and a cross sectional view thereof taken along line A-A, FIG. 3B includes a plan view of an example of a ceramic sheet SH1 of the multilayer body and a cross sectional view thereof taken along line B-B, FIG. 3C includes a plan view of an example of a ceramic sheet SH2 of the multilayer body and a cross sectional view thereof taken along line C-C, and FIG. 3D includes a plan view of an example of a ceramic sheet SH3 of the multilayer body and a cross sectional view thereof taken along line D-D.

FIG. 4A includes a plan view of an example of a ceramic sheet SH4 of the multilayer body and a cross sectional view thereof taken along line E-E, FIG. 4B includes a plan view of an example of a ceramic sheet SH5 of the multilayer body and a cross sectional view thereof taken along line F-F, and FIG. 4C includes a plan view of an example of a ceramic sheet SH6 of the multilayer body and a cross sectional view thereof taken along line G-G.

FIG. 5 is a perspective view showing an outward appearance of the multilayer body.

FIG. 6 is a cross sectional view of the multilayer body shown in FIG. 5 and other electronic components taken along line H-H.

FIG. 7A is a process chart of a portion of a manufacturing process of the ceramic sheet SH0, FIG. 7B is a process chart of another portion of the manufacturing process of the ceramic sheet SH0, and FIG. 7C is a process chart of the other portion of the manufacturing process of the ceramic sheet SH0.

FIG. 8A is a process chart of a portion of a manufacturing process of the ceramic sheet SH1, FIG. 8B is a process chart of another portion of the manufacturing process of the ceramic sheet SH1, FIG. 8C is a process chart of yet another portion of the manufacturing process of the ceramic sheet SH1, and FIG. 8D is a process chart of the other portion of the manufacturing process of the ceramic sheet SH1.

FIG. 9A is a process chart of a portion of a manufacturing process of the ceramic sheet SH2, FIG. 9B is a process chart of another portion of the manufacturing process of the ceramic sheet SH2, FIG. 9C is a process chart of yet another portion of the manufacturing process of the ceramic sheet SH2, and FIG. 9D is a process chart of the other portion of the manufacturing process of the ceramic sheet SH2.

FIG. 10A is a process chart of a portion of a manufacturing process of the ceramic sheet SH3, FIG. 10B is a process chart of another portion of the manufacturing process of the ceramic sheet SH3, FIG. 10C is a process chart of yet another portion of the manufacturing process of the ceramic sheet SH3, and FIG. 10D is a process chart of the other portion of the manufacturing process of the ceramic sheet SH3.

FIG. 11A is a process chart of a portion of a manufacturing process of the ceramic sheet SH4, FIG. 11B is a process chart of another portion of the manufacturing process of the ceramic sheet SH4, FIG. 11C is a process chart of yet another portion of the manufacturing process of the ceramic sheet SH4, and FIG. 11D is a process chart of the other portion of the manufacturing process of the ceramic sheet SH4.

FIG. 12A is a process chart of a portion of a manufacturing process of the ceramic sheet SH5, FIG. 12B is a process chart of another portion of the manufacturing process of the ceramic sheet SH5, and FIG. 12C is a process chart of the other portion of the manufacturing process of the ceramic sheet SH5.

FIG. 13A is a process chart of a portion of a manufacturing process of the ceramic sheet SH6, FIG. 13B is a process chart of another portion of the manufacturing process of the ceramic sheet SH6, FIG. 13C is a process chart of yet another portion of the manufacturing process of the ceramic sheet SH6, and FIG. 13D is a process chart of the other portion of the manufacturing process of the ceramic sheet SH6.

FIG. 14A is a process chart of a portion of a manufacturing process of the multilayer ceramic electronic component, FIG. 14B is a process chart of another portion of the manufacturing process of the multilayer ceramic electronic component, and FIG. 14C is a process chart of the other portion of the manufacturing process of the multilayer ceramic electronic component.

FIGS. 15A-15C are process charts of yet another portion of the manufacturing process of the multilayer ceramic electronic component.

FIG. 16 is a cross sectional view illustrating a cross section of a multilayer body that defines a multilayer ceramic electronic component according to another preferred embodiment of the present invention.

FIG. 17 is a cross sectional view illustrating a cross section of a multilayer body that defines a multilayer ceramic electronic component according to yet another preferred embodiment of the present invention.

### DETAILED DESCRIPTION OF THE PREFERRED EMBODIMENTS

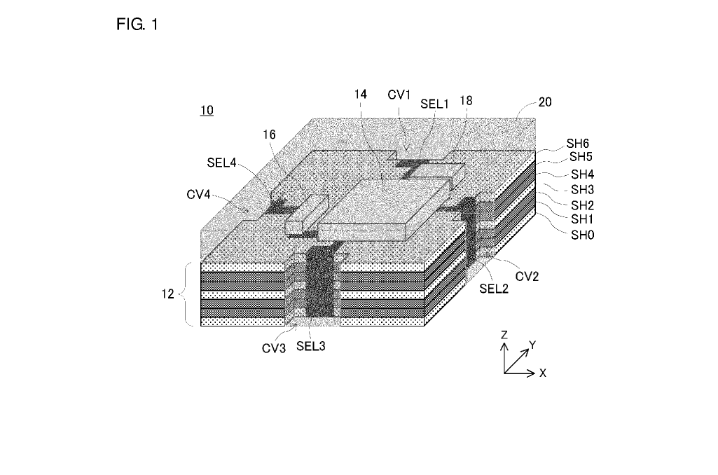

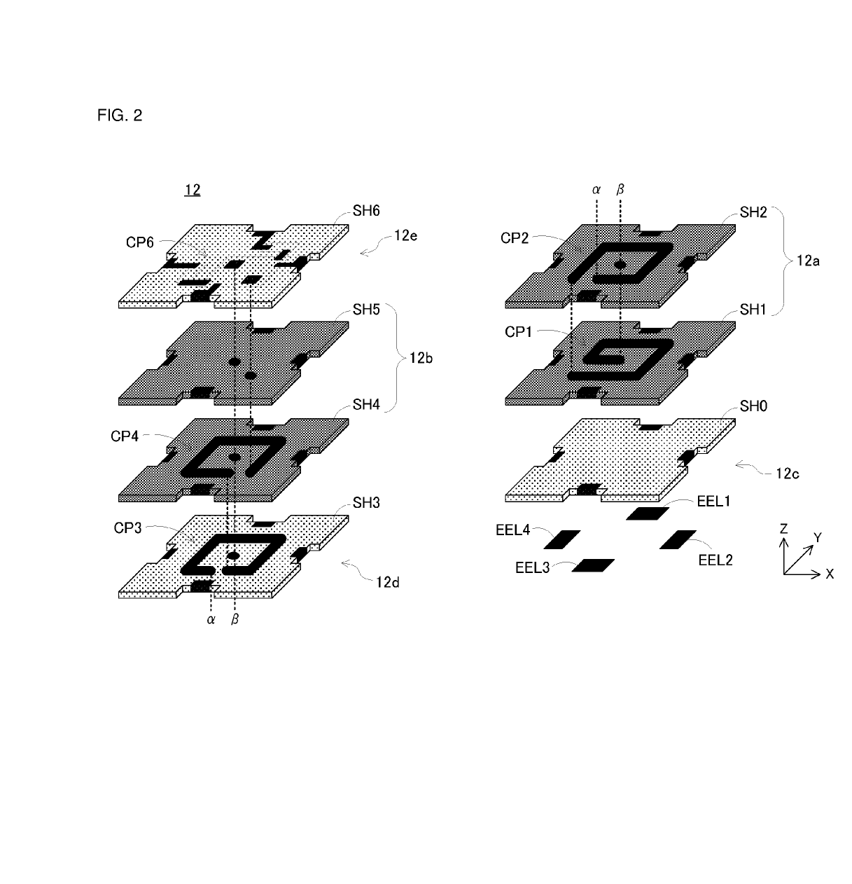

Referring to FIGS. 1 and 2, a multilayer ceramic electronic component 10 according to a preferred embodiment of the present invention is a surface mount DC-to-DC converter, and includes ceramic sheets SH0 to SH6 each of which includes a main surface of the same or substantially the same size and shape. The main surfaces of all the ceramic sheets SH0 to SH6 are preferably square or substantially square, the four sides of which are each cut out preferably rectangular or substantially rectangular. The ceramic sheets SH0, SH3, and SH6 are nonmagnetic, while the ceramic sheets SH1, SH2, SH4, and SH5 are magnetic.

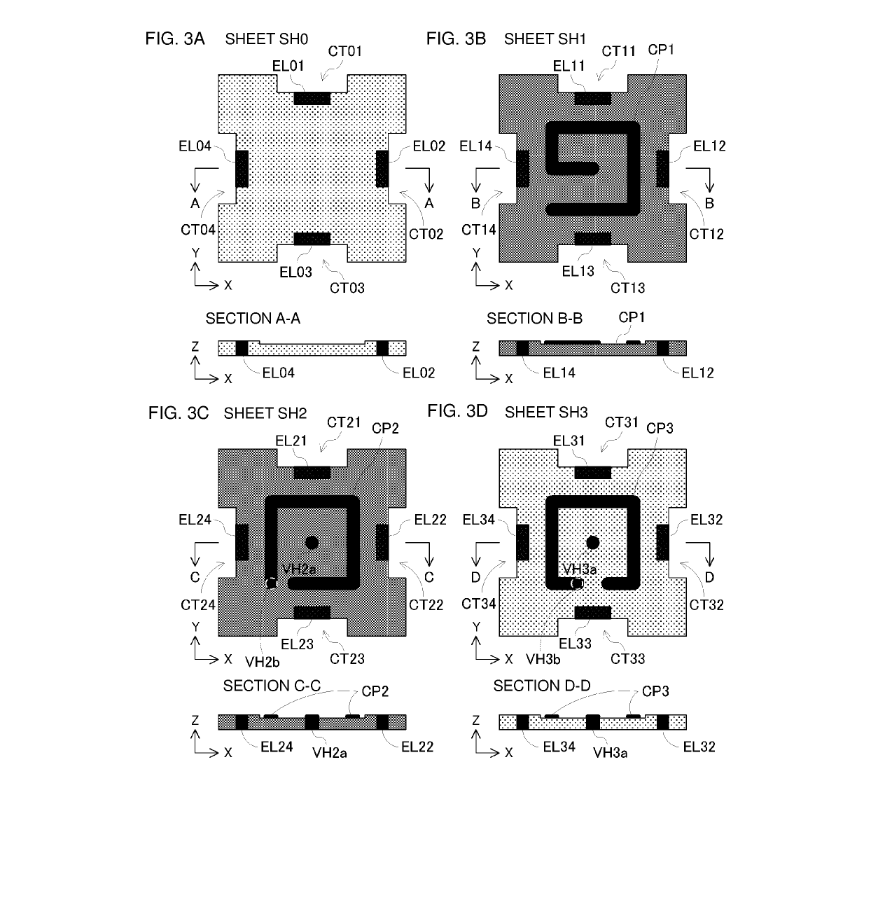

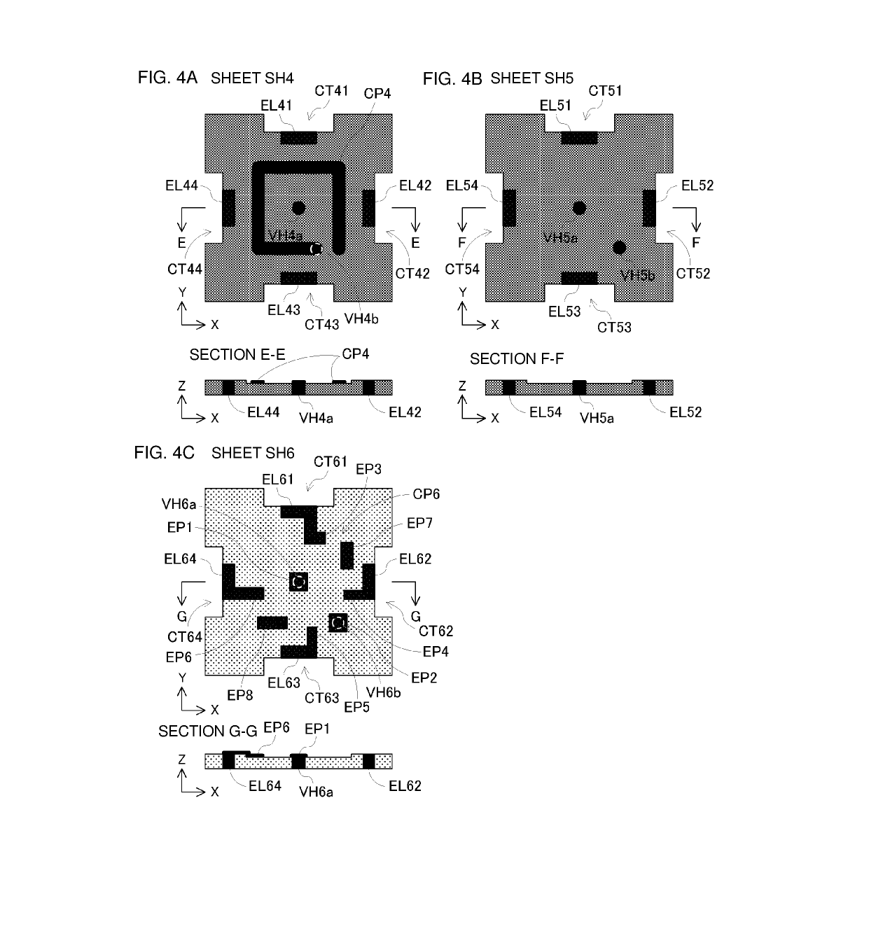

The structures of the ceramic sheets SH1 to SH6 will be first described. As described later with reference to FIGS. 3A-3D and FIGS. 4A-4C, the ceramic sheets SH1 to SH4 and SH6 include conductive patterns CP1 to CP4 and CP6, respectively, provided on the main surfaces. The ceramic sheet SH0 includes cutouts CT01 to CT04 and electrodes EL01 to EL04 provided therein, the ceramic sheet SH1 includes cutouts CT11 to CT14 and electrodes EL11 to EL14 provided therein, and the ceramic sheet SH2 includes cutouts CT21 to CT24 and electrodes EL21 to EL24 provided therein.

The ceramic sheet SH3 includes cutouts CT31 to CT34 and electrodes EL31 to EL34 provided therein, the ceramic sheet SH4 includes cutouts CT41 to CT44 and electrodes EL41 to EL44 provided therein, the ceramic sheet SH5 includes cutouts CT51 to CT54 and electrodes EL51 to EL54 provided therein, and the ceramic sheet SH6 includes cutouts CT61 to CT64 and electrodes EL61 to EL64 provided therein.

Laminating the ceramic sheets SH0 to SH6 produces a multilayer body 12. To be more specific, in the multilayer body 12 that preferably has a rectangular or substantially rectangular parallelepiped shape, the ceramic sheets SH1 and SH2 define a magnetic layer 12a, the ceramic sheets SH4 and SH5 define a magnetic layer 12b, the ceramic sheet SH0 defines a nonmagnetic layer 12c, the ceramic sheet SH3 defines a nonmagnetic layer 12d, and the ceramic sheet SH6 defines a nonmagnetic layer 12e.

Thus, the magnetic layer 12a is sandwiched between the nonmagnetic layers 12c and 12d, and the magnetic layer 12b is sandwiched between the nonmagnetic layers 12d and 12e. Each side of a rectangle or an approximate rectangle that circumscribes an outline of a main surface (top surface or bottom surface) of the multilayer body 12 extends along an X axis or a Y axis, and the thickness of the multilayer body 12 increases along a Z axis.

On a top surface of the multilayer body 12, an IC 14 and passive elements (e.g. capacitors) 16 and 18 are mounted. In side surfaces of the multilayer body 12, cavities CV1 to CV4 and bonding electrodes SEL1 to SEL4 are provided. On a bottom surface of the multilayer body 12, outer electrodes EEL1 to EEL4 are provided in a continuous arrangement from the bonding electrodes SEL1 to SEL4, respectively.

The cavity CV1 is defined by the cutouts CT01 to CT61, the cavity CV2 is defined by the cutouts CT02 to CT62, the cavity CV3 is defined by the cutouts CT03 to CT63, and the cavity CV4 is defined by the cutouts CT04 to CT64. The bonding electrode SEL1 is defined by the electrodes EL01 to EL61, the bonding electrode SEL2 is defined by the electrodes EL02 to EL62, the bonding electrode SEL3 is defined by the electrodes EL03 to EL63, and the bonding electrode SEL4 is defined by the electrodes EL04 to EL64.

The bonding electrode SEL1 is exposed at a bottom surface of the cavity CV1, the bonding electrode SEL2 exposed at a bottom surface of the cavity CV2, the bonding electrode SEL3 is exposed at a bottom surface of the cavity CV3, and the bonding electrode SEL4 is exposed at a bottom surface of the cavity CV4. A sealing resin 20 is provided on the top surface of the multilayer body 12 so as to extend into the cavities CV1 to CV4. The IC 14, the passive elements 16 and 18, and the bonding electrodes SEL1 to SEL4 are sealed with the sealing resin 20.

Referring to an upper portion of FIG. 3A, the ceramic sheet SH0 is a square or substantially square sheet including the rectangular or substantially rectangular cutouts CT01 to CT04 in four sides thereof. The electrode EL01 is provided on the side including the cutout CT01 so as to extend inward from the cutout CT01. The electrode EL02 is provided on the side including the cutout CT02 so as to extend inward from the cutout CT02.

The electrode EL03 is provided on the side including the cutout CT03 so as to extend inward from the cutout CT03. The electrode EL04 is provided on the side including the cutout CT04 so as to extend inward from the cutout CT04. Note that, a lower portion of FIG. 3A shows a section A-A of the ceramic sheet SH0.

Referring to an upper portion of FIG. 3B, the ceramic sheet SH1 is a square or substantially square sheet including the rectangular or substantially rectangular cutouts CT11 to CT14 in four sides thereof. The electrode EL11 is provided on the side having the cutout CT11 so as to extend inward from the cutout CT11. The electrode EL12 is provided on the side including the cutout CT12 so as to extend inward from the cutout CT12. The electrode EL13 is provided on the side including the cutout CT13 so as to extend inward from the cutout CT13. The electrode EL14 is provided on the side including the cutout CT14 so as to extend inward from the cutout CT14.

On the top surface of the ceramic sheet SH1, the loop-shaped conductive pattern CP1 is provided. The loop of the conductive pattern CP1 starts from the center of the top surface of the ceramic sheet SH1 and ends at a position on negative sides in the directions of the X axis and the Y axis, with respect to the center of the top surface, so as to extend on the top surface of the ceramic sheet SH1 in a clockwise direction.

The conductive pattern CP1 extends from the start position to a negative side in the direction of the X axis, and bends to a positive side in the direction of the Y axis before reaching the electrode EL14. The bent conductive pattern CP1 further bends and extends to a positive side in the direction of the X axis at an inside position relative to the cutout CT11, without overlapping the electrode EL11.

The conductive pattern CP1, which is extended to the positive side in the direction of the X axis, bends again and extends to a negative side in the direction of the Y axis at an inside position relative to the cutout CT12, without overlapping the electrode EL12. The conductive pattern CP1, which has extended to the negative side in the direction of the Y axis, further bends to the negative side in the direction of the X axis at an inside position relative to the cutout CT13. The bent conductive pattern CP1 extends to the negative side in the direction of the X axis without overlapping the electrode EL13, and reaches the end position. Note that, a lower portion of FIG. 3B shows a section B-B of the ceramic sheet SH1.

Referring to an upper portion of FIG. 3C, the ceramic sheet SH2 is a square or substantially square sheet including the rectangular or substantially rectangular cutouts CT21 to CT24 in four sides thereof. The electrode EL21 is provided on the side including the cutout CT21 so as to extend inward from the cutout CT21. The electrode EL22 is provided on the side including the cutout CT22 so as to extend inward from the cutout CT22. The electrode EL23 is provided on the side including the cutout CT23 so as to extend inward from the cutout CT23. The electrode EL24 is provided on the side including the cutout CT24 so as to extend inward from the cutout CT24.

On the top surface of the ceramic sheet SH2, via hole conductors VH2a and VH2b, which extend to the bottom surface, and the loop-shaped conductive pattern CP2 are provided. The via hole conductor VH2a overlaps the start position of the conductive pattern CP1, when the ceramic sheet SH2 is laminated on the ceramic sheet SH1. The via hole conductor VH2b overlaps the end position of the conductive pattern CP1, when the ceramic sheet SH2 is laminated on the ceramic sheet SH1.

The loop of the conductive pattern CP2 starts from the position of the via hole conductor VH2b and ends at a position that slightly deviates from the start position to the positive side in the direction of the X axis, so as to extend on the top surface of the ceramic sheet SH2 in the clockwise direction.

The conductive pattern CP2 extends from the start position to the positive side in the direction of the Y axis, and bends to the positive side in the direction of the X axis at an inside position relative to the cutout CT21. The bent conductive pattern CP2 bends and extends farther to the negative side in the direction of the Y axis at an inside position relative to the cutout CT22, without overlapping the electrode EL22. The conductive pattern CP2, which has extended to the negative side in the direction of the Y axis, bends again to the negative side in the direction of the X axis at an inside position relative to the cutout CT23. The bent conductive pattern CP2 extends to the negative side in the direction of the X axis without overlapping the electrode EL23, and reaches the end position. Note that, a lower portion of FIG. 3C shows a section C-C of the ceramic sheet SH2.

Referring to an upper portion of FIG. 3D, the ceramic sheet SH3 is a square or substantially square sheet including the rectangular or substantially rectangular cutouts CT31 to CT34 in four sides thereof. The electrode EL31 is provided on the side including the cutout CT31 so as to extend inward from the cutout CT31. The electrode EL32 is provided on the side including the cutout CT32 so as to extend inward from the cutout CT32. The electrode EL33 is provided on the side including the cutout CT33 so as to extend inward from the cutout CT33. The electrode EL34 is provided on the side including the cutout CT34 so as to extend inward from the cutout CT34.

On the top surface of the ceramic sheet SH3, via hole conductors VH3a and VH3b, which extend to the bottom surface, and the loop-shaped conductive pattern CP3 are provided. The via hole conductor VH3a overlaps the via hole conductor VH2a, when the ceramic sheet SH3 is laminated on the ceramic sheet SH2. The via hole conductor VH3b overlaps the end position of the conductive pattern CP2, when the ceramic sheet SH3 is laminated on the ceramic sheet SH2.

The loop of the conductive pattern CP3 starts from the position of the via hole conductor VH3b and ends at a position that slightly deviates from the start position to the positive side in the direction of the X axis, so as to extend on the top surface of the ceramic sheet SH3 in the clockwise direction.

The conductive pattern CP3 extends from the start position to the negative side in the direction of the X axis, and bends to the positive side in the direction of the Y axis at an inside position relative to the cutout CT34. The bent conductive pattern CP3 extends to the positive side in the direction of the Y axis without overlapping the electrode EL34, and further bends to the positive side in the direction of the X axis at an inside position relative to the cutout CT31.

The bent conductive pattern CP3 extends to the positive side in the direction of the X axis without overlapping the electrode EL31, and bends again to the negative side in the direction of the Y axis at an inside position relative to the cutout CT32. The bent conductive pattern CP3 extends to the negative side in the direction of the Y axis without overlapping the electrode EL32, and further bends to the negative side in the direction of the X axis at an inside position relative to the cutout CT33. The bent conductive pattern CP3 thereafter reaches the end position. Note that, a lower portion of FIG. 3D shows a section D-D of the ceramic sheet SH3.

Referring to an upper portion of FIG. 4A, the ceramic sheet SH4 is a square or substantially square sheet including the rectangular or substantially rectangular cutouts CT41 to CT44 in four sides thereof. The electrode EL41 is provided on the side including the cutout CT41 so as to extend inward from the cutout CT41. The electrode EL42 is provided on the side including the cutout CT42 so as to extend inward from the cutout CT42. The electrode EL43 is provided on the side including the cutout CT43 so as to extend inward from the cutout CT43. The electrode EL44 is provided on the side including the cutout CT44 so as to extend inward from the cutout CT44.

On the top surface of the ceramic sheet SH4, via hole conductors VH4a and VH4b, which extend to the bottom surface, and the loop-shaped conductive pattern CP4 are provided. The via hole conductor VH4a overlaps the via hole conductor VH3a, when the ceramic sheet SH4 is laminated on the ceramic sheet SH3. The via hole conductor VH4b overlaps the end position of the conductive pattern CP3, when the ceramic sheet SH4 is laminated on the ceramic sheet SH3.

The loop of the conductive pattern CP4 starts from the position of the via hole conductor VH4b and ends at a position that slightly deviates from the start position to the positive side in the direction of the X axis, so as to extend on the top surface of the ceramic sheet SH4 in the clockwise direction.

The conductive pattern CP4 extends from the start position to the negative side in the direction of the X axis, and bends to the positive side in the direction of the Y axis at an inside position relative to the cutout CT44. The bent conductive pattern CP4 extends to the positive side in the direction of the Y axis without overlapping the electrode EL44, and further bends to the positive side in the direction of the X axis at an inside position relative to the cutout CT41. The bent conductive pattern CP4 extends to the positive side in the direction of the X axis without overlapping the electrode EL41, and bends again to the negative side in the direction of the Y axis at an inside position relative to the cutout CT42. The bent conductive pattern CP4 extends to the negative side in the direction of the Y axis without overlapping the electrode EL42, and reaches the end position. Note that, a lower portion of FIG. 4A shows a section E-E of the ceramic sheet SH4.

Referring to an upper portion of FIG. 4B, the ceramic sheet SH5 is a square or substantially square sheet including the rectangular or substantially rectangular cutouts CT51 to CT54 in four sides thereof. The electrode EL51 is provided on the side including the cutout CT51 so as to extend inward from the cutout CT51. The electrode EL52 is provided on the side including the cutout CT52 so as to extend inward from the cutout CT52. The electrode EL53 is provided on the side including the cutout CT53 so as to extend inward from the cutout CT53. The electrode EL54 is provided on the side including the cutout CT54 so as to extend inward from the cutout CT54.

On the top surface of the ceramic sheet SH5, via hole conductors VH5a and VH5b extend to the bottom surface. The via hole conductor VH5a overlaps the via hole conductor VH4a, when the ceramic sheet SH5 is laminated on the ceramic sheet SH4. The via hole conductor VH5b overlaps the end position of the conductive pattern CP4, when the ceramic sheet SH5 is laminated on the ceramic sheet SH4. Note that, a lower portion of FIG. 4B shows a section F-F of the ceramic sheet SH5.

Referring to an upper portion of FIG. 4C, the ceramic sheet SH6 is a square or substantially square sheet including the rectangular or substantially rectangular cutouts CT61 to CT64 in four sides thereof. The electrode EL61 is provided on the side including the cutout CT61 so as to extend inward from the cutout CT61. The electrode EL62 is provided on the side including the cutout CT62 so as to extend inward from the cutout CT62. The electrode EL63 is provided on the side including the cutout CT63 so as to extend inward from the cutout CT63. The electrode EL64 is provided on the side including the cutout CT64 so as to extend inward from the cutout CT64.

On the top surface of the ceramic sheet SH6, via hole conductors VH6a and VH6b extend to the bottom surface. The via hole conductor VH6a overlaps the via hole conductor VH5a, when the ceramic sheet SH6 is laminated on the ceramic sheet SH5. The via hole conductor VH6b overlaps the via hole conductor VH5b, when the ceramic sheet SH6 is laminated on the ceramic sheet SH5.

On the top surface of the ceramic sheet SH6, the conductive pattern CP6 is provided. The conductive pattern CP6 includes a plurality of dispersed electrodes EP1 to EP8. The electrode EP1 is provided at a position that covers the via hole conductor VH6a, and the electrode EP2 is provided at a position that covers the via hole conductor VH6b. The electrodes EP3 to EP6 are connected to the electrodes EL61 to EL64, respectively, while the electrodes EP7 and EP8 are independent. Note that, a lower portion of FIG. 4C shows a section G-G of the ceramic sheet SH6.

Since the ceramic sheets SH1 to SH6 are structured as above, the conductive patterns CP1 to CP4 and the via hole conductors VH2a to VH6a and VH2b to VH6b are connected in a coil shape so as to provide a wound body that is wound around a Z axis inside the multilayer body 12. Since magnetic substances are provided in inner and outer side portions of the wound body, the wound body defines and functions as an inductor.

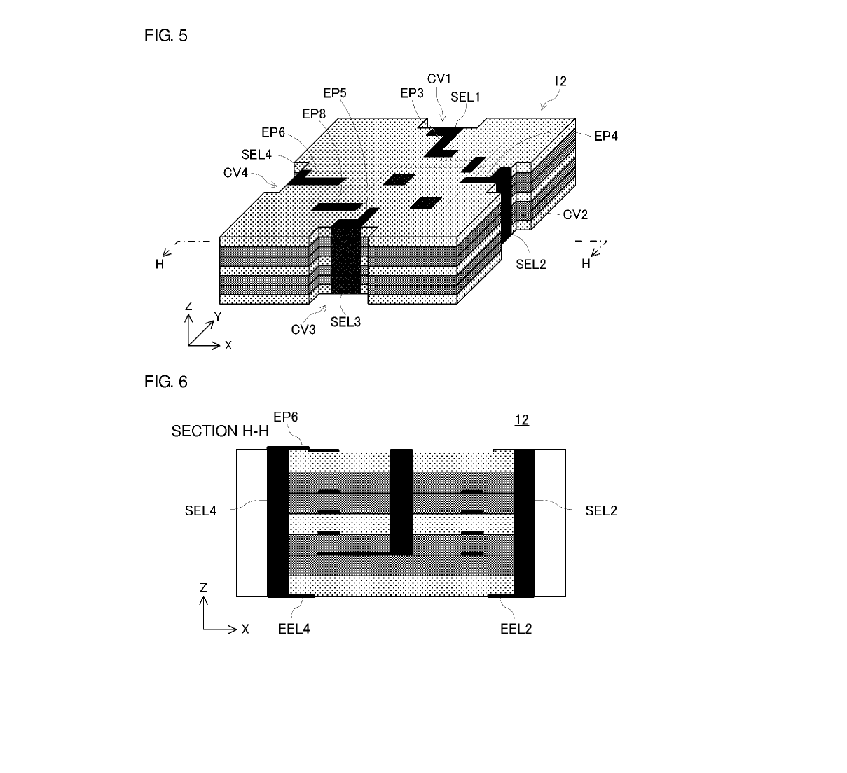

The multilayer body 12 into which the ceramic sheets SH1 to SH6 are laminated is structured as shown in a perspective view of FIG. 5. The cavity CV1 defined by the cutouts =01 to CT61 is provided in a side surface on the positive side in the direction of the Y axis, while the cavity CV2 defined by the cutouts CT02 to CT62 is provided in a side surface on the positive side in the direction of the X axis. The cavity CV3 defined by the cutouts CT03 to CT63 is provided in a side surface on the negative side in the direction of the Y axis, while the cavity CV4 defined by the cutouts CT04 to CT64 is provided in a side surface on the negative side in the direction of the X axis.

Furthermore, the bonding electrode SEL1 defined by the electrodes EL01 to EL61 is provided in the bottom surface of the cavity CV1, and the bonding electrode SEL2 defined by the electrodes EL02 to EL62 is provided in the bottom surface of the cavity CV2. The bonding electrode SEL3 defined by the electrodes EL03 to EL63 is provided in the bottom surface of the cavity CV3, and the bonding electrode SEL4 defined by the electrodes EL04 to EL64 is provided in the bottom surface of the cavity CV4.

Note that, in the top surface of the multilayer body 12, mounting positions of the IC 14 and the passive elements 16 and 18 are illustrated by alternate long and short dashed lines. FIG. 6 shows a structure of a section H-H of the multilayer body 12 shown in FIG. 5.

The ceramic sheets SH0, SH3, and SH6 are preferably made of nonmagnetic ferrite (relative permeability of 1) having a thermal expansion coefficient in the range of about 8.5 to about 9.0, for example. The ceramic sheets SH1, SH2, SH4, and SH5 are preferably made of magnetic ferrite (relative permeability of 100 to 120) having a thermal expansion coefficient in the range of about 9.0 to about 10.0, for example. The bonding electrodes SEL1 to SEL4, the conductive patterns CP1 to CP4, and the via hole conductors VH2a to VH6a and VH2b to VH6b are preferably made of silver having a thermal expansion coefficient of about 20, for example. The sealing resin 20 is preferably made of an epoxy resin with a filler such as silica, for example.

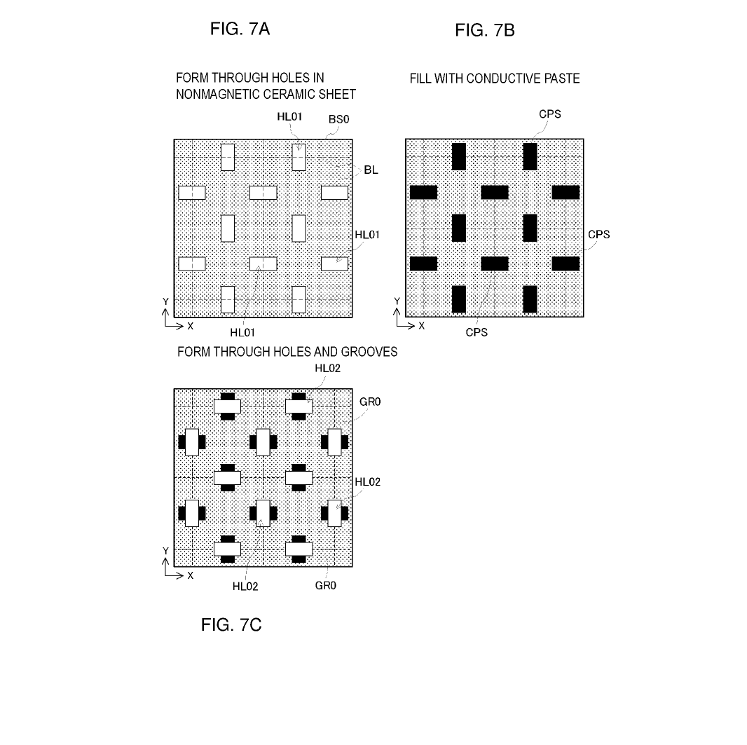

Next, a non-limiting example of a method for manufacturing the ceramic sheets SH1 to SH6 will be described. An aggregation of the ceramic sheets SH0 is manufactured in steps shown in FIGS. 7A to 7C. First, a ceramic sheet made of a nonmagnetic ferrite material is prepared as a mother sheet BS0, and a plurality of first through holes HL01, HL01, . . . each of which preferably is rectangular or substantially rectangular, are formed (see FIG. 7A).

A plurality of broken lines (border lines) BL, BL, . . . extending in the directions of the X axis and the Y axis represent dicing positions. Each of a plurality of rectangles or substantial rectangles defined by the broken lines BL is defined as a “divided unit”. The first through holes HL01 are formed by preferably using a mechanical punching device so as to straddle the broken lines BL. Short sides of each rectangular or substantially rectangular first through hole HL01 extend along a broken line BL that the first through hole HL01 straddles, while long sides of the rectangular or substantially rectangular first through hole HL01 extend in a direction orthogonal or substantially orthogonal to the broken line BL that the first through hole HL01 straddles.

The plurality of first through holes HL01, HL01, . . . are filled with conductive paste CPS (see FIG. 7B). This conductive paste CPS forms the electrodes EL01 to EL04. After this conductive paste CPS dries, a plurality of second through holes HL02, HL02, . . . each of which is preferably rectangular or substantially rectangular and grooves GR0, GR0, . . . extending along the broken lines BL, BL, . . . are formed (see FIG. 7C).

The second through holes HL02 are also formed preferably using the mechanical punching device so as to straddle the broken lines BL. The size of the second through holes HL02 preferably is equal or substantially equal that of the first through holes HL01. However, short sides of each rectangular or substantially rectangular second through hole HL02 extend in a direction orthogonal or substantially orthogonal to a broken line BL that the second through hole HL02 straddles, while long sides of the rectangular or substantially rectangular second through hole HL02 extend along the broken line BL that the second through hole HL02 straddles. Thus, only a portion of the conductive paste CPS is removed, while the other portion remains in the mother sheet BS0. The grooves GR0, GR0, . . . are formed on each of top and bottom surfaces of the mother sheet BS0 so as to extend along the broken lines BL, BL, . . . . Note that, the grooves formed on the bottom surface preferably have greater widths than the grooves formed on the top surface.

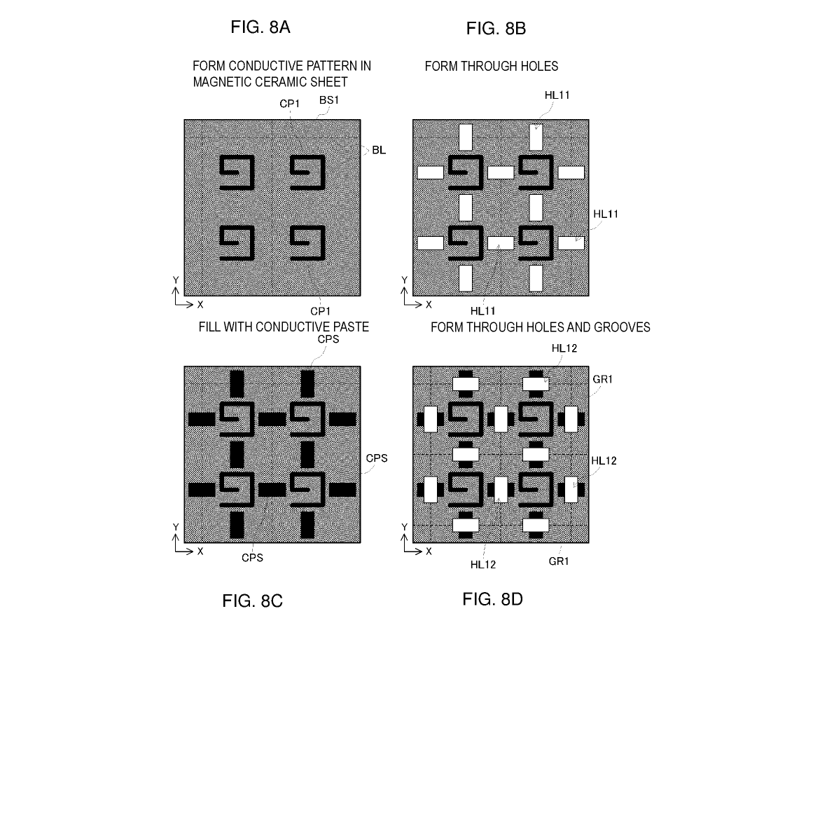

An aggregation of the ceramic sheets SH1 is manufactured in steps shown in FIGS. 8A-8D. First, a ceramic sheet made of a magnetic ferrite material is prepared as a mother sheet BS1, and a conductive pattern CP1 extending in a loop shape is formed on a top surface of each divided unit by screen printing (see FIG. 8A). Note that, a plurality of broken lines (border lines) BL, BL, . . . extending in the directions of the X axis and the Y axis represent dicing positions.

Next, a plurality of first through holes HL11, HL11, . . . each of which preferably is rectangular or substantially rectangular are formed in the mother sheet BS1 (see FIG. 8B). The first through holes HL11 are formed preferably by using the mechanical punching device so as to straddle the broken lines BL. Short sides of each rectangular or substantially rectangular first through hole HL11 extend along a broken line BL that the first through hole HL11 straddles, while long sides of the rectangular or substantially rectangular first through hole HL11 extend in a direction orthogonal or substantially orthogonal to the broken line BL that the first through hole HL11 straddles.

After that, the plurality of formed first through holes HL11, HL11, . . . are filled with the conductive paste CPS (see FIG. 8C). This conductive paste CPS forms the electrodes EL11 to EL14.

After letting this conductive paste CPS dry, a plurality of second through holes HL12, HL12, . . . each of which is preferably rectangular or substantially rectangular and grooves GR1, GR1, . . . extending along the broken lines BL, BL, . . . are formed (see FIG. 8D).

The second through holes HL12 are also formed preferably using the mechanical punching device so as to straddle the broken lines BL. The size of the second through holes HL12 is equal or substantially equal to of the first through holes HL11. However, short sides of each rectangular or substantially rectangular second through hole HL12 extend in a direction orthogonal or substantially orthogonal to a broken line BL that the second through hole HL12 straddles, while long sides of the rectangular second through hole HL12 extend along the broken line BL that the second through hole HL12 straddles. Thus, only a portion of the conductive paste CPS is removed, while the other portion remains in the mother sheet BS1. The grooves GR1, GR1, . . . are formed on each of top and bottom surfaces of the mother sheet BS1 so as to extend along the broken lines BL, BL, . . . . Note that, the grooves formed on the bottom surface preferably have greater widths than the grooves formed on the top surface.

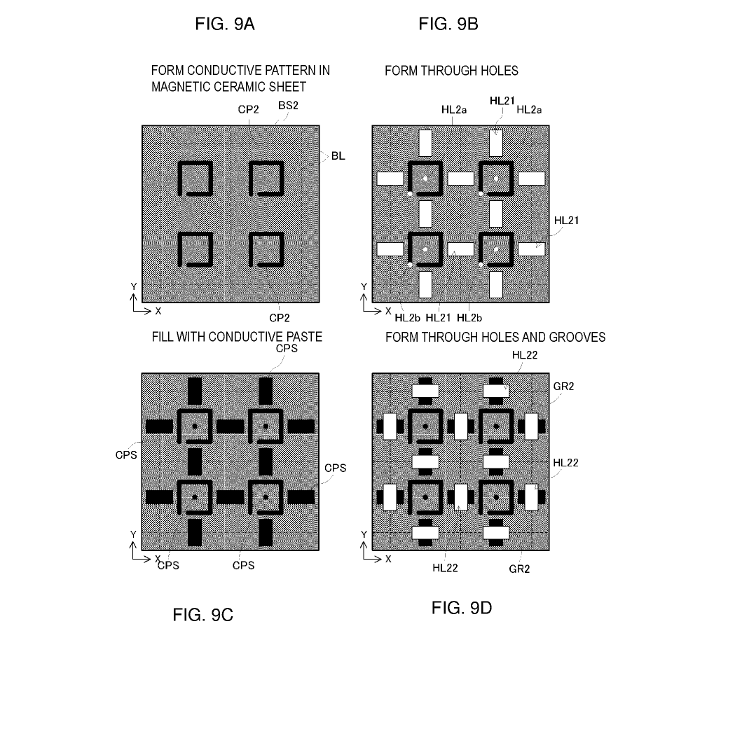

An aggregation of the ceramic sheets SH2 is manufactured in steps shown in FIGS. 9A-9D. First, a ceramic sheet made of a magnetic ferrite material is prepared as a mother sheet BS2, and a conductive pattern CP2 extending in a loop shape is formed on a top surface of each divided unit by screen printing (see FIG. 9A). Note that, a plurality of broken lines (border lines) BL, BL, . . . extending in the directions of the X axis and the Y axis represent dicing positions.

Next, a plurality of first through holes HL21, HL21, . . . each of which is preferably rectangular or substantially rectangular and a plurality of third through holes HL2a, HL2a, . . . , HL2b, HL2b, . . . each of which is in a round shape are formed (see FIG. 9B). The first through holes HL21 are formed preferably using the mechanical punching device so as to straddle the broken lines BL. Short sides of each rectangular or substantially rectangular first through hole HL21 extend along a broken line BL that the first through hole HL21 straddles, while long sides of the rectangular or substantially rectangular first through hole HL21 extend in a direction orthogonal or substantially orthogonal to the broken line BL that the first through hole HL21 straddles. The third through holes HL2a and HL2b are formed preferably using a laser device. The third through hole HL2a is formed at the center or approximate center of each divided unit, while the third through hole HL2b is formed at the start position of the conductive pattern CP2.

After that, the first through holes HL21, HL21, . . . and the third through holes HL2a, HL2a, . . . , HL2b, HL2b, . . . are filled with the conductive paste CPS (see FIG. 9C). The conductive paste CPS with which the first through holes HL21, HL21, . . . are filled forms the electrodes EL21 to EL24, the conductive paste CPS with which the third through holes HL2a are filled forms the via hole conductors VH2a, and the conductive paste CPS with which the third through holes HL2b are filled forms the via hole conductors VH2b.

After letting this conductive paste CPS dry, a plurality of second through holes HL22, HL22, . . . each of which is preferably rectangular or substantially rectangular and grooves GR2, GR2, . . . extending along the broken lines BL, BL, . . . are formed (see FIG. 9D).

The second through holes HL22 are also formed preferably using the mechanical punching device so as to straddle the broken lines BL. The size of the second through holes HL22 is equal or substantially equal to of the first through holes HL21. However, short sides of each rectangular or substantially rectangular second through hole HL22 extend in a direction orthogonal or substantially orthogonal to a broken line BL that the second through hole HL22 straddles, while long sides of the rectangular or substantially rectangular second through hole HL22 extend along the broken line BL that the second through hole HL22 straddles. Thus, only a portion of the conductive paste CPS is removed, while the other portion remains in the mother sheet BS2. The grooves GR2, GR2, . . . are formed on each of top and bottom surfaces of the mother sheet BS2 so as to extend along the broken lines BL, BL, . . . . Note that, the grooves formed on the bottom surface preferably have greater widths than the grooves formed on the top surface.

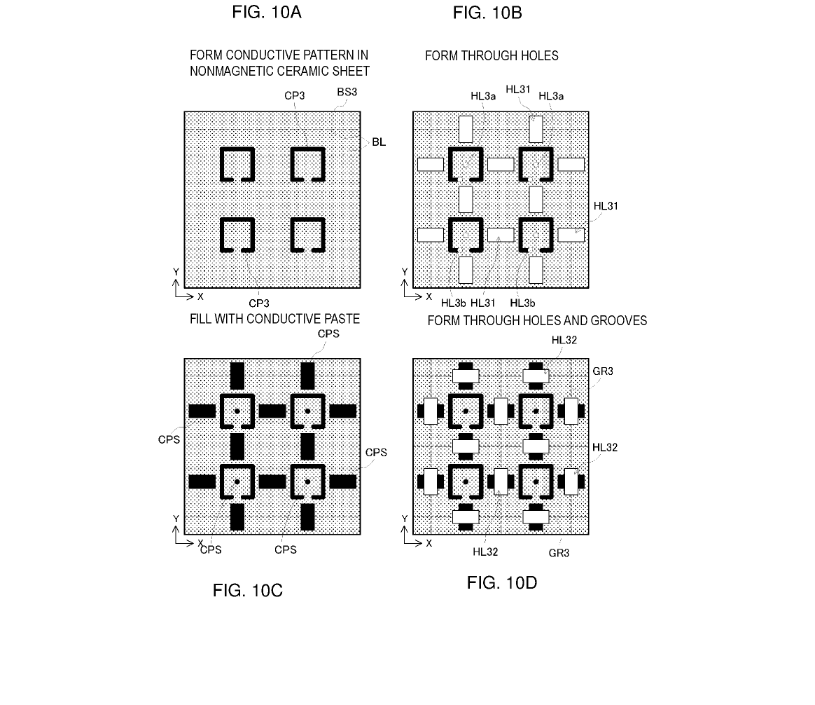

An aggregation of the ceramic sheets SH3 is manufactured in steps shown in FIGS. 10A-10D. First, a ceramic sheet preferably made of a nonmagnetic ferrite material is prepared as a mother sheet BS3, and a conductive pattern CP3 extending in a loop shape is formed on a top surface of each divided unit by screen printing (see FIG. 10A). Note that, a plurality of broken lines (border lines) BL, BL, . . . extending in the directions of the X axis and the Y axis represent dicing positions.

Next, a plurality of first through holes HL31, HL31, . . . each of which is preferably rectangular or substantially rectangular and a plurality of third through holes HL3a, HL3a, . . . , HL3b, HL3b, . . . each of which is in a round or substantially round shape are provided (see FIG. 10B). The first through holes HL31 are formed by preferably using the mechanical punching device so as to straddle the broken lines BL. Short sides of each rectangular or substantially rectangular first through hole HL31 extend along a broken line BL that the first through hole HL31 straddles, while long sides of the rectangular or substantially rectangular first through hole HL31 extend in a direction orthogonal or substantially orthogonal to the broken line BL that the first through hole HL31 straddles. The third through holes HL3a and HL3b are formed preferably using the laser device. The third through hole HL3a is provided at the center or approximate of each divided unit, while the third through hole HL3b is provided at the start position of the conductive pattern CP3.

After that, the first through holes HL31, HL31, . . . and the third through holes HL3a, HL3a, . . . , HL3b, HL3b, . . . are filled with the conductive paste CPS (see FIG. 10C). The conductive paste CPS with which the first through holes HL31, HL31, . . . are filled forms the electrodes EL31 to EL34, the conductive paste CPS with which the third through holes HL3a are filled forms the via hole conductors VH3a, and the conductive paste CPS with which the third through holes HL3b are filled forms the via hole conductors VH3b.

After letting this conductive paste CPS dry, a plurality of second through holes HL32, HL32, . . . each of which is preferably rectangular or substantially rectangular and grooves GR3, GR3, . . . extending along the broken lines BL, BL, . . . are formed (see FIG. 10D).

The second through holes HL32 are also formed preferably using the mechanical punching device so as to straddle the broken lines BL. The size of the second through holes HL32 is equal or substantially equal to of the first through holes HL31. However, short sides of each rectangular or substantially rectangular second through hole HL32 extend in a direction orthogonal or substantially orthogonal to a broken line BL that the second through hole HL32 straddles, while long sides of the rectangular or substantially rectangular second through hole HL32 extend along the broken line BL that the second through hole HL32 straddles. Thus, only a portion of the conductive paste CPS is removed, while the other portion remains in the mother sheet BS3. The grooves GR3, GR3, . . . are formed on each of top and bottom surfaces of the mother sheet BS3 so as to extend along the broken lines BL, BL, . . . . Note that, the grooves formed on the bottom surface preferably have greater widths than the grooves formed on the top surface.

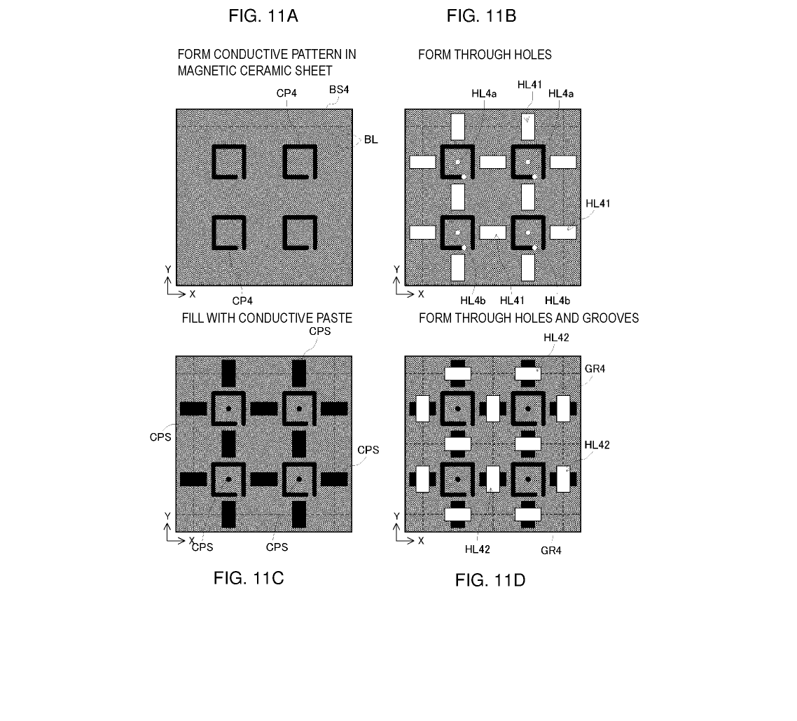

An aggregation of the ceramic sheets SH4 is manufactured in steps shown in FIGS. 11A-11D. First, a ceramic sheet made of a magnetic ferrite material is prepared as a mother sheet BS4, and a conductive pattern CP4 extending in a loop shape is formed on a top surface of each divided unit by screen printing (see FIG. 11A). Note that, a plurality of broken lines (border lines) BL, BL, . . . extending in the directions of the X axis and the Y axis represent dicing positions.

Next, a plurality of first through holes HL41, HL41, . . . each of which is preferably rectangular or substantially rectangular and a plurality of third through holes HL4a, HL4a, . . . , HL4b, HL4b, . . . each of which is in a round or substantially round shape are formed (see FIG. 11B). The first through holes HL41 are formed preferably using the mechanical punching device so as to straddle the broken lines BL. Short sides of each rectangular or substantially rectangular first through hole HL41 extend along a broken line BL that the first through hole HL41 straddles, while long sides of the rectangular or substantially rectangular first through hole HL41 extend in a direction orthogonal or substantially orthogonal to the broken line BL that the first through hole HL41 straddles. The third through holes HL4a and HL4b are formed preferably using the laser device. The third through hole HL4a is formed at the center or approximate center of each divided unit, while the third through hole HL4b is formed at the start position of the conductive pattern CP4.

After that, the first through holes HL41, HL41, . . . and the third through holes HL4a, HL4a, . . . , HL4b, HL4b, . . . are filled with the conductive paste CPS (see FIG. 11C). The conductive paste CPS with which the first through holes HL41, HL41, . . . are filled forms the electrodes EL41 to EL44, the conductive paste CPS with which the third through holes HL4a are filled forms the via hole conductors VH4a, and the conductive paste CPS with which the third through holes HL4b are filled forms the via hole conductors VH4b.

After letting this conductive paste CPS dry, a plurality of second through holes HL42, HL42, . . . each of which is preferably rectangular or substantially rectangular and grooves GR4, GR4, . . . extending along the broken lines BL, BL, . . . are formed (see FIG. 11D).

The second through holes HL42 are also formed preferably using the mechanical punching device so as to straddle the broken lines BL. The size of the second through holes HL42 is equal or substantially equal to of the first through holes HL41. However, short sides of each rectangular or substantially rectangular second through hole HL42 extend in a direction orthogonal or substantially orthogonal to a broken line BL that the second through hole HL42 straddles, while long sides of the rectangular or substantially rectangular second through hole HL42 extend along the broken line BL that the second through hole HL42 straddles. Thus, only a portion of the conductive paste CPS is removed, while the other portion remains in the mother sheet BS4. The grooves GR4, GR4, . . . are formed on each of top and bottom surfaces of the mother sheet BS4 so as to extend along the broken lines BL, BL, . . . . Note that, the grooves formed on the bottom surface preferably have greater widths than the grooves formed on the top surface.

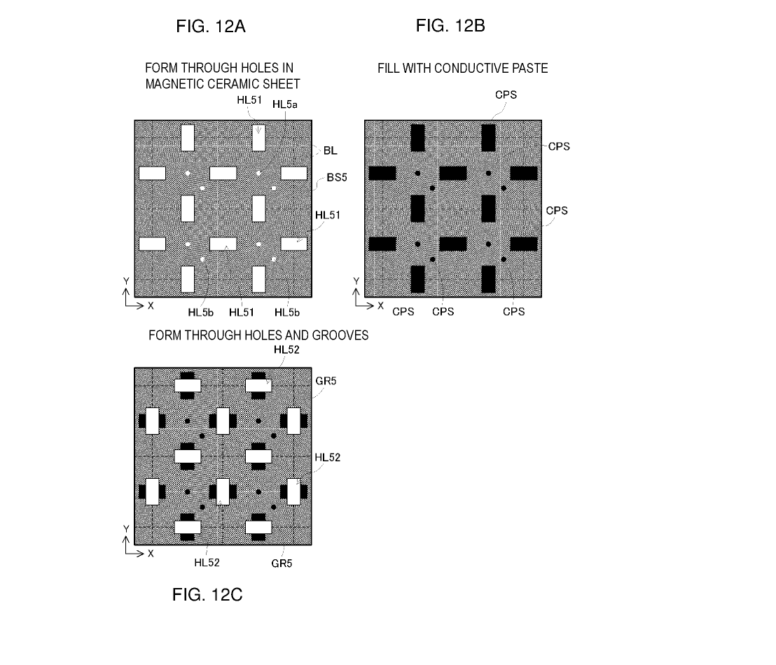

An aggregation of the ceramic sheets SH5 is manufactured in steps shown in FIGS. 12A-12C. First, a ceramic sheet made of a magnetic ferrite material is prepared as a mother sheet BS5, and a plurality of first through holes HL51, HL51, . . . each of which is preferably rectangular or substantially rectangular and a plurality of third through holes HL5a, HL5a, . . . , HL5b, HL5b, . . . each of which is in a round or substantially round shape are formed in the mother sheet BS5 (see FIG. 12A). Note that, a plurality of broken lines (border lines) BL, BL, . . . extending in the directions of the X axis and the Y axis represent dicing positions.

The first through holes HL51 are formed preferably using the mechanical punching device so as to straddle the broken lines BL. Short sides of each rectangular or substantially rectangular first through hole HL51 extend along a broken line BL that the first through hole HL51 straddles, while long sides of the rectangular or substantially rectangular first through hole HL51 extend in a direction orthogonal or substantially orthogonal to the broken line BL that the first through hole HL51 straddles. The third through holes HL5a and HL5b are formed preferably using the laser device. The third through hole HL5a is formed at the center or approximate center of each divided unit, while the third through hole HL5b is formed at a position on the positive side in the direction of the X axis and on the negative side in the direction of the Y direction, with respect to the position of the third through hole HL5a.

After that, the first through holes HL51, HL51, . . . and the third through holes HL5a, HL5a, . . . , HL5b, HL5b, . . . are filled with the conductive paste CPS (see FIG. 12B). The conductive paste CPS with which the first through holes HL51, HL51, . . . are filled forms the electrodes EL51 to EL54, the conductive paste CPS with which the third through holes HL5a are filled forms the via hole conductors VH5a, and the conductive paste CPS with which the third through holes HL5b are filled forms the via hole conductors VH5b.

After letting this conductive paste CPS dry, a plurality of second through holes HL52, HL52, . . . each of which is preferably rectangular or substantially rectangular and grooves GR5, GR5, . . . extending along the broken lines BL, BL, . . . are formed (see FIG. 12C).

The second through holes HL52 are also formed preferably using the mechanical punching device so as to straddle the broken lines BL. The size of the second through holes HL52 is equal or substantially equal to of the first through holes HL51. However, short sides of each rectangular or substantially rectangular second through hole HL52 extend in a direction orthogonal or substantially orthogonal to a broken line BL that the second through hole HL52 straddles, while long sides of the rectangular or substantially rectangular second through hole HL52 extend along the broken line BL that the second through hole HL52 straddles. Thus, only a portion of the conductive paste CPS is removed, while the other portion remains in the mother sheet BS5. The grooves GR5, GR5, . . . are formed on each of top and bottom surfaces of the mother sheet BS5 so as to extend along the broken lines BL, BL, . . . . Note that, the grooves formed on the bottom surface preferably have greater widths than the grooves formed on the top surface.

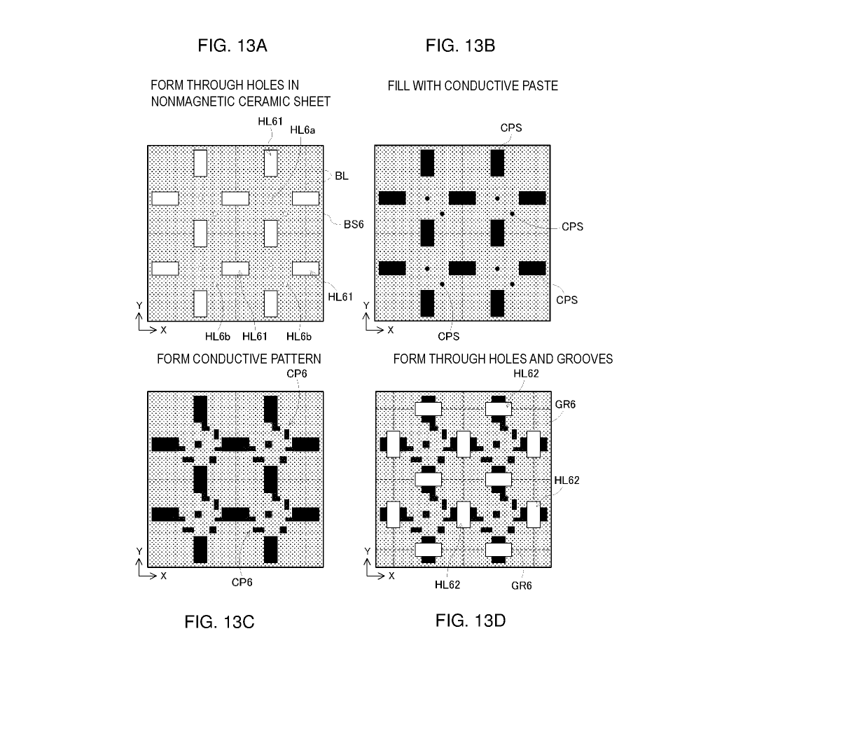

An aggregation of the ceramic sheets SH6 is manufactured in steps shown in FIGS. 13A-13D. First, a ceramic sheet made of a nonmagnetic ferrite material is prepared as a mother sheet BS6, and a plurality of first through holes HL61, HL61, . . . each of which is preferably rectangular or substantially rectangular and a plurality of third through holes HL6a, HL6a, . . . , HL6b, HL6b, . . . each of which is in a round or substantially round shape are formed in the mother sheet BS6 (see FIG. 13A). Note that, a plurality of broken lines (border lines) BL, BL, . . . extending in the directions of the X axis and the Y axis represent dicing positions.

The first through holes HL61 are formed preferably using the mechanical punching device so as to straddle the broken lines BL. Short sides of each rectangular or substantially rectangular first through hole HL61 extend along a broken line BL that the first through hole HL61 straddles, while long sides of the rectangular or substantially rectangular first through hole HL61 extend in a direction orthogonal or substantially orthogonal to the broken line BL that the first through hole HL61 straddles. The third through holes HL6a and HL6b are formed preferably using the laser device. The third through hole HL6a is formed at the center or approximate of each divided unit, while the third through hole HL6b is formed at a position on the positive side in the direction of the X axis and on the negative side in the direction of the Y direction, with respect to the position of the third through hole HL6a.

After that, the first through holes HL61, HL61, . . . and the third through holes HL6a, HL6a, . . . , HL6b, HL6b, . . . are filled with the conductive paste CPS (see FIG. 13B). The conductive paste CPS with which the first through holes HL61, HL61, . . . are filled forms the electrodes EL61 to EL64, the conductive paste CPS with which the third through holes HL6a are filled forms the via hole conductors VH6a, and the conductive paste CPS with which the third through holes HL6b are filled forms the via hole conductors VH6b.

After letting this conductive paste CPS dry, a plurality of second through holes HL62, HL62, . . . each of which is preferably rectangular or substantially rectangular and grooves GR6, GR6, . . . extending along the broken lines BL, BL, . . . are formed (see FIG. 13D).

The second through holes HL62 are also formed preferably using the mechanical punching device so as to straddle the broken lines BL. The size of the second through holes HL62 is equal or substantially equal to of the first through holes HL61. However, short sides of each rectangular or substantially rectangular second through hole HL62 extend in a direction orthogonal or substantially orthogonal to a broken line BL that the second through hole HL62 straddles, while long sides of the rectangular or substantially rectangular second through hole HL62 extend along the broken line BL that the second through hole HL62 straddles. Thus, only a portion of the conductive paste CPS is removed, while the other portion remains in the mother sheet BS6. The grooves GR6, GR6, . . . are formed on each of top and bottom surfaces of the mother sheet BS6 so as to extend along the broken lines BL, BL, . . . . Note that, the grooves formed on the bottom surface preferably have greater widths than the grooves formed on the top surface.

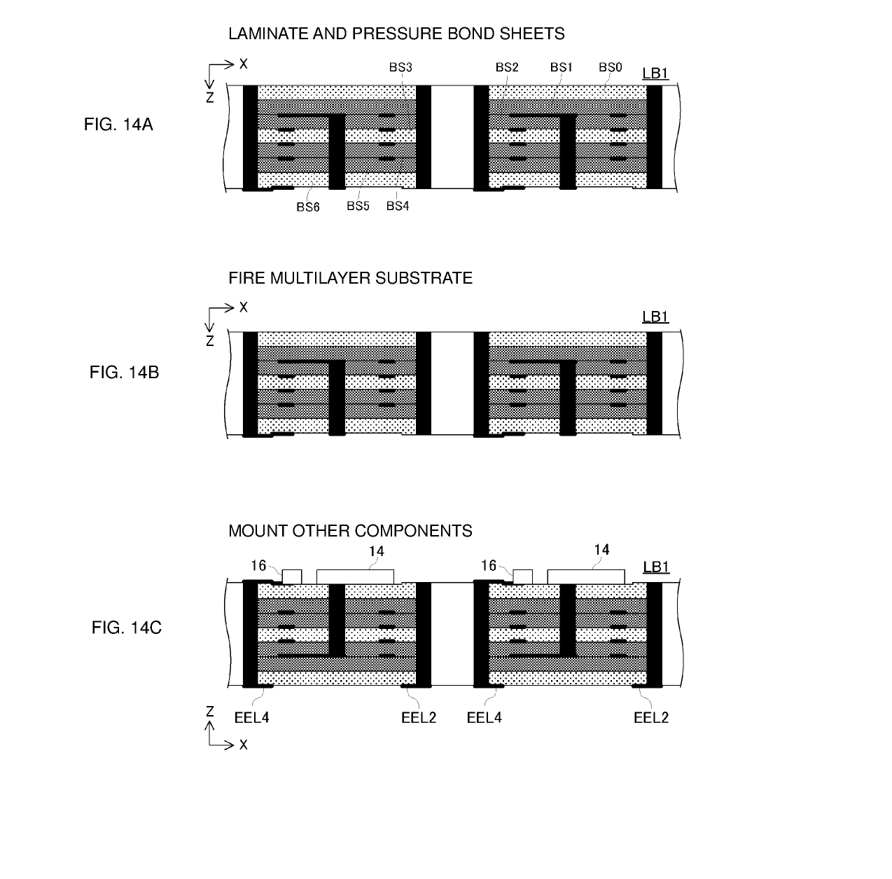

The mother sheets BS0 to BS6 manufactured by the above steps are laminated and pressure bonded in this order. The lamination position is adjusted such that the broken lines BL, BL, . . . provided in each sheet overlap when viewed from the direction of the Z axis. In other words, the second through holes HL02 to HL62 formed in the individual sheets overlap when viewed from the direction of the Z axis. Thus, a multilayer substrate LB1 is manufactured as shown in FIG. 14A. The manufactured multilayer substrate LB1 is thereafter fired (see FIG. 14B). After completing the firing, the ICs 14 and the passive elements 16 and 18 are mounted on the top surface of the multilayer substrate LB1 on a divided unit-by-divided unit arrangement, and the outer electrodes EEL1 to EEL4, which are continuous from the bonding electrodes SEL1 to SEL4, respectively, are mounted on the bottom surface of the multilayer substrate LB1 on a divided unit-by-divided unit arrangement (see FIG. 14C).

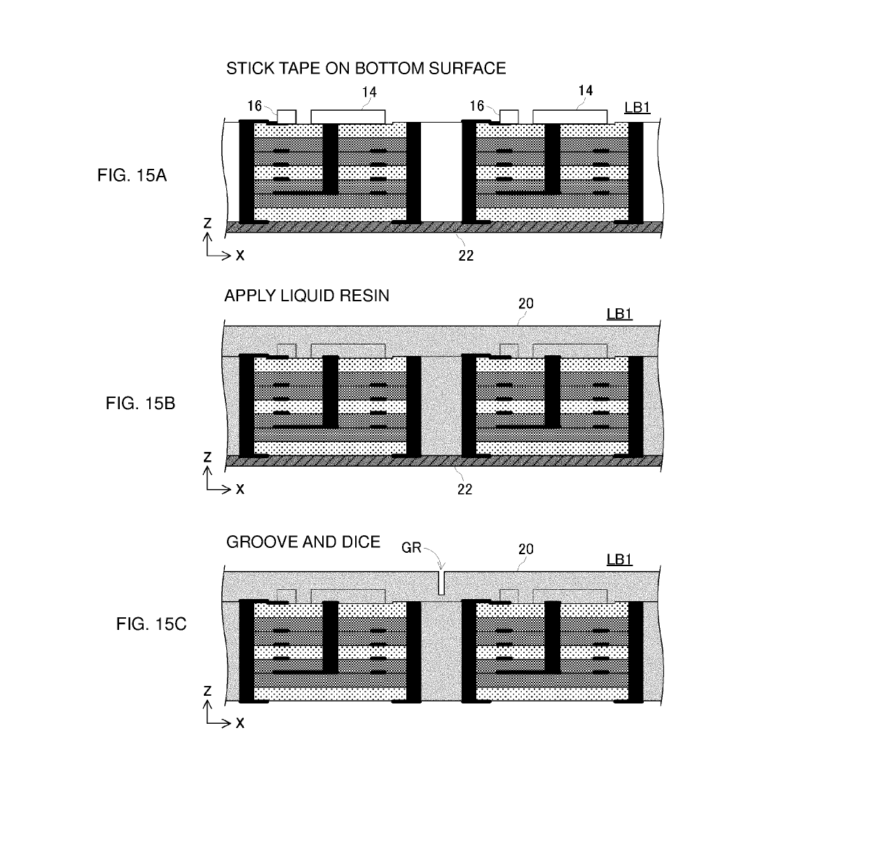

Subsequently, a flexible tape 22 is adhered in an air-tight manner to the bottom surface of the multilayer substrate LB1 (see FIG. 15A). To be more specific, the tape 22 is adhered to the bottom surface of the multilayer substrate LB1 in a vacuum, and pressed by rubber gum with atmospheric pressure. After the adhering of the tape 22, a liquid sealing resin 20 is applied to the top surface of the multilayer substrate LB1, and subjected to a vacuum degassing process and a curing process (see FIG. 15B). Note that, the applied sealing resin 20 flows into the second through holes HL02 to HL62 and is blocked by the tape 22.

After the curing of the sealing resin 20, grooves GR7 that extend along the broken lines BL, BL, . . . are formed on a surface of the sealing resin 20 (see FIG. 15C). The multilayer substrate LB1 is diced (divided) into the divided units along the formed grooves GR7. Therefore, a plurality of multilayer ceramic electronic components 10, 10, . . . are obtained.

As is understood from the above description, the multilayer body 12 includes the ceramic sheets SH0 to SH6 laminated on one another. The IC 14 and the passive elements 16 and 18 are mounted on the top surface of the multilayer body 12, and the cavities CV1 to CV4 are provided in the side surfaces of the multilayer body 12. In the bottom surfaces of the cavities CV1 to CV4, the bonding electrodes SEL1 to SEL4 are provided, respectively. The sealing resin 20 is provided on the top surface of the multilayer body 12 to seal the IC 14 and the passive elements 16 and 18, and extends into the cavities CV1 to CV4 to seal the bonding electrodes SEL1 to SEL4.

To manufacture the above-described multilayer ceramic electronic component 10, the mother sheets BS0 to BS6, which include the first through holes HL01 to HL61, respectively, formed in common positions, are prepared (preparation step). Next, the first through holes HL01 to HL61 are filled with the conductive paste CPS to form the bonding electrodes SEL1 to SEL4 (first filling step), and the conductive patterns CP1, CP2, CP4, and CP5 are formed on the mother sheets BS1, BS2, BS4, and BS5, respectively (conductive pattern forming step).

The third through holes HL2a to HL6a and HL2b to HL6b are formed in the mother sheets BS2 to BS6, respectively, in order to connect the conductive patterns CP1, CP2, CP4, and CP5 in a helical manner (third through hole forming step), and the third through holes HL2a to HL6a and HL2b to HL6b are filled with the conductive paste CPS (second filling step).

After completing the second filling step, the second through holes HL02 to HL62 are formed in the mother sheets BS0 to BS6 (second through hole forming step). The formation of the second through holes HL02 to HL62 removes a portion of the conductive paste CPS. After that, the mother sheets BS0 to BS6 are laminated so as to overlap the second through holes HL02 to HL62 (laminating step) when viewed in a plan view, and the multilayer substrate LB1 is therefore manufactured.

The ICs 14 and the passive elements 16 and 18 are mounted on the top surface of the multilayer substrate LB1 (mounting step), and the outer electrodes EEL1 to EEL4, which are continuous from the bonding electrodes SEL1 to SEL4, respectively, are formed on the bottom surface of the multilayer substrate LB1 (outer electrode forming step). Subsequently, the tape 22 is adhered to the bottom surface of the multilayer substrate LB1 (adhering step), and the liquid sealing resin 20 is applied to the top surface of the multilayer substrate LB1 (resin applying step).

The applied sealing resin 20 extends into the second through holes HL02 to HL62. After curing of the sealing resin 20, the multilayer substrate LB1 is diced at a position across the second through holes HL02 to HL62 (dicing step). Thus, the plurality of multilayer ceramic electronic components 10, 10, . . . are obtained.

Using the resin as a material of a component to seal the IC 14, the passive elements 16 and 18, and the bonding electrodes SEL1 to SEL4 reduce a risk of absorption of moisture from an area between each of the bonding electrodes SEL1 to SEL4 and ceramic, and a risk of a wetting-up of solder that bonds between the multilayer ceramic electronic component 10 and a mother board (not shown) to extend to the top surface of the multilayer body 12 through the cavities CV1 to CV4.

In this preferred embodiment, the second through holes HL02 to HL62 preferably are formed before laminating the ceramic sheets SH0 to SH6. However, other second through holes that penetrate the positions of the second through holes HL02 to HL62 may be formed in the multilayer substrate LB1 after laminating the ceramic sheets SH0 to SH6. As long as the other second through holes are formed in the multilayer substrate LB1, the other second through holes may be formed before and/or after the firing of the multilayer substrate LB1.

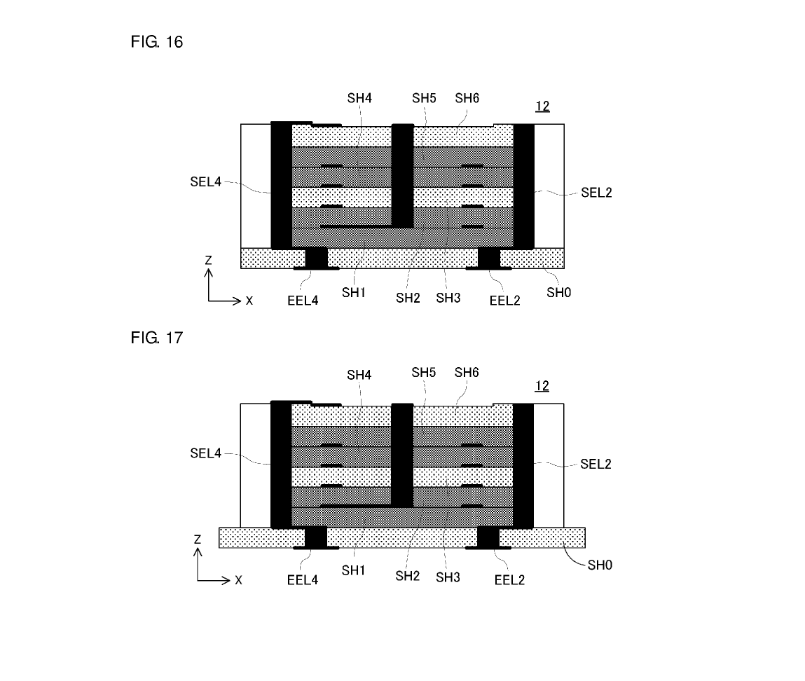

In this preferred embodiment, each of the cavities CV1 to CV4 is preferably provided on the side surface of the multilayer body 12 so as to extend to the top surface and the bottom surface of the multilayer body 12. However, each of the cavities CV1 to CV4 may be provided on the side surface of the multilayer body 12 so as not to extend to the top surface or the bottom surface of the multilayer body 12. In this case, a cross section (corresponding to the section H-H of FIG. 6) of the multilayer body 12 has a structure as shown in FIG. 16.

In FIG. 16, through holes penetrate from top to bottom surfaces of the ceramic sheet SH0 in positions overlapping the outer electrodes EEL1 to EEL4 in a plan view, and conductors are provided on the top surface of the ceramic sheet SH0 and in the through holes. The bonding electrodes SEL1 to SEL4 are connected to the outer electrodes EEL1 to EEL4, respectively, through the conductors. Manufacturing a multilayer ceramic electronic component 10 including this multilayer body 12 eliminates the step of adhering the tape 22 on the bottom surface of the multilayer substrate LB1 (see FIG. 15A).

Furthermore, in the multilayer body 12 shown in FIG. 16, the area of the ceramic sheet SH0 preferably is equal or substantially equal to of each of the ceramic sheets SH1 to SH6. However, the area of the ceramic sheet SH0 may be larger than the area of each of the ceramic sheets SH1 to SH6. In this case, a cross section (corresponding to the section of FIG. 16) of the multilayer body 12 has a structure as shown in FIG. 17.

The multilayer body 12 shown in FIG. 16 or 17 may be manufactured by the same or similar manufacturing method as the multilayer body 12 shown in FIG. 1, except for the different structure.

In this preferred embodiment, the inductor that is wound around the Z axis is provided inside the multilayer body 12 (see FIG. 2). However, an inductor that is wound around the X axis may be provided inside the multilayer body 12. The number of turns in the inductor is arbitrary, and even may include zero turns, as long as the inductor has an inductance component.

In this preferred embodiment, the ceramic sheets SH0, SH3, and SH6 are preferably nonmagnetic sheets. However, all of the ceramic sheets SH0 to SH6 may be magnetic sheets.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including a plurality of laminated ceramic sheets; and
a sealing resin provided on a first surface of the multilayer body; wherein
the multilayer body includes a cavity in a side surface thereof, a bonding electrode extending in a lamination direction is exposed at the cavity, and the sealing resin extends from the first surface of the multilayer body into the cavity and seals the bonding electrode.

2. The multilayer ceramic electronic component according to claim 1, wherein
the side surface of the multilayer body is a flat or substantially flat surface, except for an area of the cavity of the side surface of the multilayer body; and
a surface of the sealing resin extending into the cavity is flush or substantially flush with the flat or substantially flat surface.

3. The multilayer ceramic electronic component according to claim 1, wherein
at least one of the plurality of ceramic sheets is a magnetic ceramic sheet; and
the multilayer ceramic electronic component further includes a coil-shaped conductive pattern provided on or in the magnetic ceramic sheet.

4. The multilayer ceramic electronic component according to claim 1, further comprising a mounted electronic component that is mounted on the first surface of the multilayer body and sealed with the sealing resin.

5. The multilayer ceramic electronic component according to claim 4, further comprising a first surface side electrode provided on the first surface of the multilayer body in a continuous arrangement from the bonding electrode, wherein the first surface side electrode connects the mounted electronic component to the bonding electrode.

6. The multilayer ceramic electronic component according to claim 1, further comprising an outer electrode provided in a continuous arrangement from the bonding electrode on a second surface of the multilayer body.

7. The multilayer ceramic electronic component according to claim 1, wherein the cavity does not extend to a second surface of the multilayer body.

8. A manufacturing method for a multilayer ceramic electronic component comprising:
a preparation step of preparing a plurality of ceramic sheets, each of the plurality of ceramic sheets including a first through hole formed at a common position;
a first filling step of filling the first through hole formed in each of the plurality of ceramic sheets with conductive paste to form a bonding electrode;
a second through hole forming step of forming a second through hole in each of the plurality of ceramic sheets so as to remove a portion of the conductive paste with which the first through hole is filled in the first filling step;
a laminating step of laminating the plurality of ceramic sheets so as to overlap the second through holes in a plan view, to produce a multilayer substrate;
a resin applying step of applying a liquid sealing resin to a first surface of the multilayer substrate such that the sealing resin extends into the second through holes; and
a dicing step of dicing the multilayer substrate at a position across the second through holes, after the resin applying step.

9. The manufacturing method for the multilayer ceramic electronic component according to claim 8, wherein
at least one of the plurality of ceramic sheets is a magnetic ceramic sheet;
the method further comprising:
a conductive pattern forming step of forming a coil-shaped conductive pattern on or in the magnetic ceramic sheet;
a third through hole forming step of forming a third through hole in at least one of the plurality of ceramic sheets so as to connect the conductive pattern formed in the conductive pattern forming step in a helical manner; and
a second filling step of filling the third through hole formed in the third through hole forming step with the conductive paste; and
the laminating step is performed after the second filling step.

10. The manufacturing method for the multilayer ceramic electronic component according to claim 8, further comprising a mounting step of mounting an electronic component on the first surface of the multilayer substrate, prior to the resin applying step.

11. The manufacturing method for the multilayer ceramic electronic component according to claim 10, further comprising a step of forming a first surface side electrode conductive pattern to connect between the mounted electronic component and the bonding electrode on the ceramic sheet defining the first surface of the multilayer substrate, in the preparation step.

12. The manufacturing method for the multilayer ceramic electronic component according to claim 8, further comprising an outer electrode forming step of forming an outer electrode on a second surface of the multilayer substrate in a continuous arrangement from the bonding electrode, prior to the resin applying step.

13. The manufacturing method for the multilayer ceramic electronic component according to claim 8, further comprising an adhering step of adhering a tape on a second surface of the multilayer substrate, prior to the resin applying step.

14. A manufacturing method for a multilayer ceramic electronic component comprising:
a preparation step of preparing a plurality of ceramic sheets, each of the plurality of ceramic sheets including a first through hole formed at a common position;
a first filling step of filling the first through hole formed in each of the plurality of ceramic sheets with conductive paste to form a bonding electrode;
a laminating step of laminating the plurality of ceramic sheets so as to overlap the first through holes in a plan view, to produce a multilayer substrate;
a second through hole forming step of forming a second through hole in the multilayer substrate so as to remove a portion of the conductive paste with which the first through hole is filled in the first filling step;
a resin applying step of applying a liquid sealing resin to a first surface of the multilayer substrate such that the sealing resin extends into the second through hole; and
a dicing step of dicing the multilayer substrate at a position across the second through hole, after the resin applying step.

15. The manufacturing method for the multilayer ceramic electronic component according to claim 14, wherein
at least one of the plurality of ceramic sheets is a magnetic ceramic sheet;
the method further comprising:
a conductive pattern forming step of forming a coil-shaped conductive pattern on or in the magnetic ceramic sheet;
a third through hole forming step of forming a third through hole in at least one of the plurality of ceramic sheets so as to connect the conductive pattern formed in the conductive pattern forming step in a helical manner; and
a second filling step of filling the third through hole formed in the third through hole forming step with the conductive paste; and
the laminating step is performed after the second filling step.

16. The manufacturing method for the multilayer ceramic electronic component according to claim 14, further comprising a mounting step of mounting another electronic component on the first surface of the multilayer substrate, prior to the resin applying step.

17. The manufacturing method for the multilayer ceramic electronic component according to claim 16, further comprising a step of forming a first surface side electrode conductive pattern to connect between the other electronic component and the bonding electrode on the ceramic sheet defining the first surface of the multilayer substrate, in the preparation step.

18. The manufacturing method for the multilayer ceramic electronic component according to claim 14, further comprising an outer electrode forming step of forming an outer electrode on a second surface of the multilayer substrate in a continuous arrangement from the bonding electrode, prior to the resin applying step.

19. The manufacturing method for the multilayer ceramic electronic component according to claim 14, further comprising an adhering step of adhering a tape on the second surface of the multilayer substrate, prior to the resin applying step.
